(19) United States
(12) Patent Application Publication
(10) Pub. No.: US 2001/0005834 A1
(43) Pub. Date: Jun. 28, 2001

(54) Personalized greeting card with electronic storage media and method of personalizing same

(76) Inventor: William E. Simpson, Lake Oswego, OR (US)

Correspondence Address: WHITEFORD, TAYLOR & PRESTON, LLP, ATTN: GREGORY M STONE, SEVEN SAINT PAUL STREET, BALTIMORE, MD, 21202-1626, US

(21) Appl. No.: 09/773,726

(22) Filed: Feb. 1, 2001

Related U.S. Application Data
(63) Continuation-in-part of application No. 09/377,108, filed on Aug. 19, 1999.
(60) Provisional application No. 60/098,570, filed on Aug. 31, 1998.

(51) Int. Cl. G06F 17/60

(52) U.S. Cl. 705/26; 705/14

(57) ABSTRACT

Method and system for enabling a first person to produce a customized gift for a second person, including: providing a computer-readable storage medium having a control program and non-customized information stored thereon; obtaining data from the first person which relates to the second person; using the data to generate a customization code; providing the gift and the customization code to the second person; causing the control program to request the customization code from the second person; and using the customization code to select information from the non-customized information to provide a customized display to the second person. The gift is preferably purchased and customized through an Internet web site or other electronic system.

### CROSS-REFERENCE TO RELATED APPLICATIONS

This application is a Continuation-in-Part Application of U.S. patent application Ser. No. 09/377,108, filed Aug. 19, 1999, by the inventor herein and entitled “Personalized Greeting Card with Electronic Storage Media and Method of Personalizing Same,” the disclosure of which is hereby incorporated by reference in its entirety, which application claims priority of U.S. Provisional Application Serial No. 60/098,570, filed Aug. 31, 1998, and which application is related to U.S. Pat. No. 5,954,194, issued Sep. 21, 1999.

### BACKGROUND OF THE INVENTION

The present invention relates to the field of gifts and cards and, more particularly, to an improved greeting card, such as a birthday card, mother's day card, or the like, having an electronic information storage media, such as a compact disk (CD), contained therein, and to a method of enabling the purchaser of the card to personalize the card for the intended recipient for whom the card was purchased. The card may optionally also include a gemstone gift, or other item of value or perceived value, contained therein in a secure and, preferably, visible manner along with the CD or other storage media.

In the past, numerous cards, such as greeting or special occasion cards, have been available in a variety of shapes and sizes and with a variety of different decorative images, indicia and/or messages thereon. Such cards are often purchased along with a separate gift item to be presented to the recipient of the gift as a complement to the gift. A variety of cards have also been made which are designed to hold a toy, novelty or gift item, such as a piece of candy or a dog biscuit, as evidenced by U.S. Pat. Nos. 4,152,865 and 4,203,516. Cards have also been constructed in the past in a manner which enables an audio cassette to be contained therein, as evidenced by U.S. Pat. No. 4,433,780.

Prior art cards, however, have not heretofore provided a card configuration which can be easily customized by the purchaser in a manner other than simply by writing with a pen on a portion of the card. Prior art cards also have failed to provide interesting and/or entertaining information tailored specifically to the person for whom the card has been purchased.

Thus, a need exists for an improved card and method of personalizing the same which overcomes the disadvantages of the prior art.

### SUMMARY OF THE INVENTION

Thus, a primary object of the present invention is to provide an improved card/gift and a method of producing the same.

A more particular object of the present invention is to provide a customizable gift which can easily and efficiently be customized by a first person for a second person.

Another object of the present invention is to provide a method which enables customized gifts to be produced which includes a customized visual and/or audio presentation.

Yet another object of the present invention is to provide a method which enables an electronic customized gift to be produced which contains information on certain gifts or novelty items selected from a plurality of possible gifts and novelty items.

A further object of the instant invention is to provide a customizable gift which can be easily customized for a variety of different people having different tastes and interests.

Another object of the present invention is to provide a customizable gift which can be easily adapted to a variety of different occasions.

Still another object of the instant invention is to provide a customizable gift and method of producing the same which takes advantage of the Internet.

Still yet another object of the instant invention is to provide a customizable gift and method of producing the same which may be distributed using a traditional point-of-purchase retail display while maintaining customizable functionality.

These and other objects and advantages are achieved by the instant invention which provides a method and system for enabling a first person to produce a customized gift for a second person, including: providing a computer-readable storage medium having a control program and non-customized information stored thereon; obtaining data from the first person which relates to the second person; using the data to generate a customization code; providing the gift and the customization code to the second person; causing the control program to request the customization code from the second person; and using the customization code to select information from the non-customized information to provide a customized display to the second person. In a first embodiment, the gift is purchased and customized through an Internet web site or other electronic system, while in a second embodiment, the gift is purchased at a retail point-of-purchase display, and is thereafter directly customized by the purchaser.

In accordance with another aspect of the invention, a customized gift is provided which includes a computer readable storage medium containing a control program and non-customized information, and a customization code. The control program is operable in response to input of the customization code to provide a customized display using information from the non-customized information selected based on the customization code.

In accordance with another aspect of the invention, a method is provided for enabling a first person to produce a customized gift for a second person, including: providing a computer-readable storage medium having a control program and non-customized information stored thereon; obtaining data from said first person which relates to the second person; using the data to generate a customization code; storing the customization code in either a database together with a unique identifier for the gift, or as a human-readable insert in the gift package; and providing the gift to the second person. In a first embodiment, the control program is operable to access the database and obtain the customization code based on the unique identifier, and to use the customization code to select information from the non-customized information to provide a customized display to the second person. Likewise, in a second embodiment, the control program is operable to prompt a user to manually input the customization code that was manually generated by the card's purchaser to select information from the non-customized information to provide a customized display to such second person.

### BRIEF DESCRIPTION OF THE DRAWINGS

Other features, objects and advantages of the subject invention will become apparent from a study of the following specification when viewed in light of the accompanying drawings, in which:

FIG. 1 shows a preferred embodiment of the greeting card device of the present invention;

FIG. 2 shows an exploded view of the embodiment of the instant invention shown in FIG. 1;

FIG. 3 schematically illustrates a first embodiment of the major system interfaces that are used in accordance with the instant invention to order, customize, and deliver the card device of the instant invention;

FIG. 4 schematically illustrates a preferred embodiment of the web site architecture used in accordance with the embodiment of FIG. 3;

FIG. 5 shows an exemplary display screen used in accordance with a first step of a preferred method employing the embodiment of FIG. 3;

FIG. 6 shows an exemplary display screen used in accordance with a second step of a preferred method employing the embodiment of FIG. 3;

FIG. 7 shows an exemplary display screen used in accordance with a third step of a preferred method employing the embodiment of FIG. 3;

FIG. 8 shows an exemplary display screen sued in accordance with a fourth step of a preferred method employing the embodiment of FIG. 3;

FIG. 9 shows an exemplary display screen used in accordance with a fifth step of a preferred method employing the embodiment of FIG. 3;

FIG. 10 schematically illustrates an exemplary embodiment of the server architecture of the fulfillment house 208 shown in FIG. 3.

FIG. 11 shows an exemplary data recordation and customization code generation card for use in a second embodiment of the instant invention.

### DETAILED DESCRIPTION OF THE PREFERRED EMBODIMENTS

The instant invention provides a gift card, as well as a method and system for enabling the purchaser of the gift card to personalize the gift card for the desired recipient thereof. The following description will describe preferred embodiments of the gift card itself, as well as the method and system for enabling personalization of the gift card. While particular embodiments of the invention are provided below, the description thereof is not meant to limit the scope of the invention, but is instead to be considered as non-limiting examples of the invention.

Prior to describing details regarding the customization features of the present invention, the gift card itself will be described below. It is noted that a suitable gift card for use in connection with the instant invention is described in U.S. Pat. No. 5,954,194, issued Sep. 21, 1999 by the instant inventor.

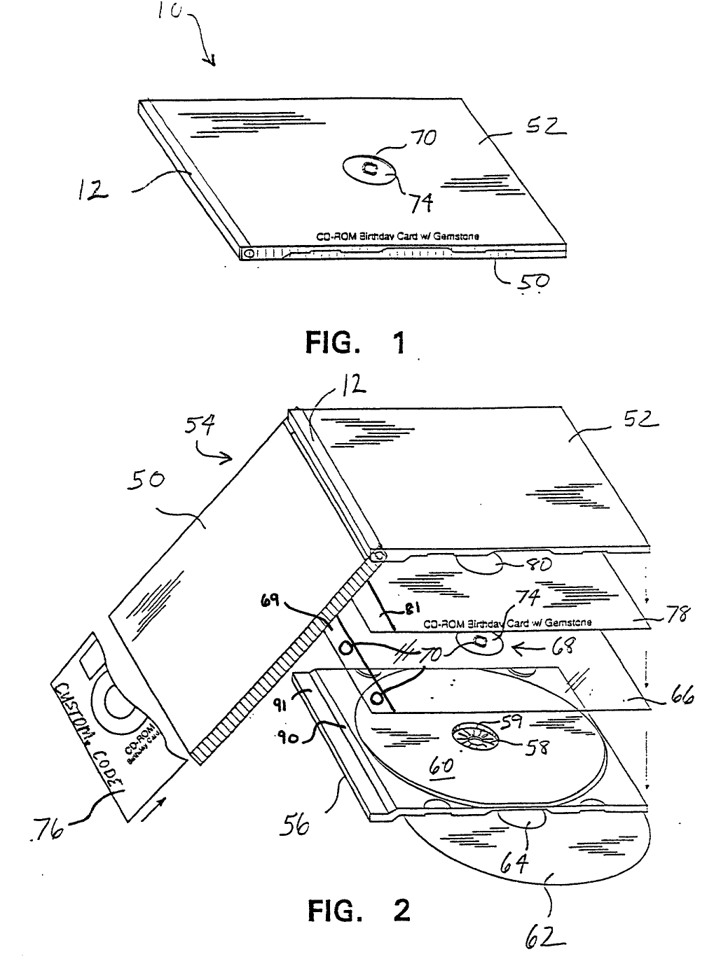

An exemplary embodiment of the instant gift card or card device 10 is shown in FIGS. 1 and 2. This embodiment is particularly adapted for incorporating a compact disk (CD) 62 or other similarly shaped storage medium in the card. The compact disk may be a CD-ROM, recordable CD, a digital video disk (DVD), or any other suitable type of computer readable storage medium. This embodiment includes a front card portion 50 and a back card portion 52 which are hinged together in a manner which enables the card 10 to be opened and closed. Preferably, the front and back card portions constitute a conventional compact disk case 54, sometimes known as a “jewel case” or “CD box.” However, any other suitably designed case 54 can be used. The case 54 has an interior space when closed. Inside the case 54 is a compact disk carrier 56 mounted within the card interior and having a central raised portion 58 and an edge-long raised portion 59 on a front side thereof. The raised portions on the front side define open recesses 59 and 91 on the back side 60 of the disk carrier 56.

The card 10 further includes a compact disk 62 positioned on the front side of the compact disk carrier 56, such that the central hole 64 on the compact disk receives the raised portion 58 on the front side of the disk carrier 56. In accordance with a preferred embodiment of the invention, the card 10 may further include a gift item carrier device 66 including a first gift carrier portion 68 and a second gift carrier portion 69, each containing one or more gift items 70, such as a gemstone or birthstone. The gift carrier device 66 preferably includes a transparent window 74 behind which the gemstone 70 is mounted with a suitable backing device or layer. The gift carrier device 66 has a size and shape which enables it and the compact disk carrier 56 to be positioned in nested relation within the interior space of the card 10. More particularly, the gift carrier portion 68 is received within the open recess 59 in the back side 60 of the compact disk carrier 56, while the gift carrier portion 69 is received within the open recess 91.

Preferably, the card case 54 is made of transparent material, and the card additionally includes a piece of sheet material 76 and 78, such as paper or card stock, inserted on the inside of the front card portion 50 and the inside of the back card portion 52, such that the sheets can be seen through the transparent case 54. The sheet 78 inside the back card portion 52 preferably contains a central hole 80 and/or an elongate edgewise window 81 therein for enabling the gemstones 70 or other gift items to be seen therethrough. The sheet material 76 can include printed information or decorative indicia, so as to transform the card device into a special occasion card, such as a birthday card or the like. The sheet 78 and gift item carrier 66 may alternatively be constructed as a single element.

In accordance with the instant invention, the CD 62 preferably contains interesting and/or fun information which relates to birthdays, the gift item, or any other type of suitable information. For example, if the gift item is a gemstone, the information on the CD may provide specific information about the gemstone. In a more specific embodiment, the card is a birthday card and the gift is a birthstone. A set of twelve such cards can be made each being tailored to one of the twelve months of the year and containing a specific birthstone for each month, respectively. Each card can be color coordinated to the color of the birthstone and may include a detailed photograph or drawing of the birthstone on the front cover 12a thereof. Information and decorative indicia may also be printed in any suitable location on the card. For example, the card could include a picture of a birth flower corresponding to the birthstone, information on an interesting event occurring in that month or an interesting person born in that month, and/or information on the stone itself, including famous examples of the stone, hardness, care and cleaning instructions, or any other desired information. The card may also include a portion for enabling the purchaser to provide a personalized written message on the card. The CD 62 may include even more detailed information relating to the gemstone or whatever gift item is contained in the card. The recipient of the card 10 can remove the CD and the gift item carrier and have the option of removing the stone and using it in a piece of jewelry.

It is of note that the card device 10 of the instant invention is not limited to an embodiment wherein a gift item is provided with the card device 10. In fact, the card device 10 may simply include the electronic storage medium or CD 62, as will be described in detail below, without any of the other features described herein. Preferably, however, the card device at least includes a carrier for holding and protecting the CD 62.

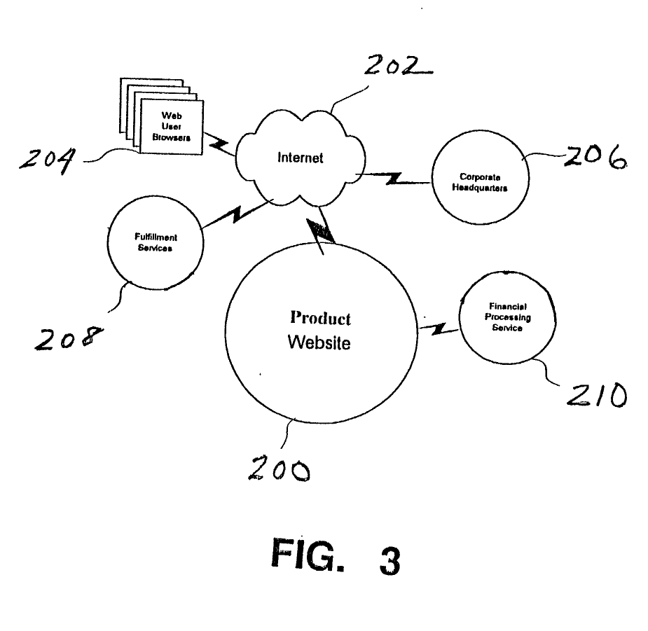

Various preferred embodiments of the system and method of purchasing, personalizing and viewing the personalized card device 10, as well as other related functions provided by the instant invention, will now be described with reference to FIGS. 3-9. The first embodiment described corresponds closely to that which is described in U.S. Provisional Patent Application No. 60/098,570 filed Aug. 31, 1998, by the instant inventor. The later embodiments represent variations on this embodiment and provide alternative methods and systems in accordance with the instant invention.

In accordance with the first embodiment of the invention, the CD greeting card 10 may be purchased on-line by the purchaser, by, for example, a specialized Internet web site or other similar type of on-line service, i.e., an e-commerce site specifically designed to handle the card purchasing transaction, as explained in detail below. The purchaser chooses the particular card he wants from, for example, a “Virtual Display Rack” on the web site which shows the various cards that are available, and then “clicks” on a “Buy” button. The available cards may be birthday cards, mother's day cards, or any other cards that a person may want to give someone for a special occasion or as simply a gift. At that point, the purchaser can choose to pay for the selected card with a credit card on-line or dial a phone number to pay over the phone. Once the purchase is approved, a “Record Personal Message” button and option appears on the web page. At this point, if the purchaser desires to provide a personalized message for the card's recipient, he may do as explained below.

In order to provide a personalized message, a screen is presented on the web page asking the purchaser for some basic data about the intended recipient of the card. For example, the purchaser may be prompted for the name and birth date (preferably day and month only) of the person to whom the purchaser intends to give the card as a gift. In addition, the purchaser is then given the option to enter a personal message on the web page for the recipient of the card. The purchaser then “clicks” a “submit button” and the data is saved to a database. The information stored is indexed in the database with a link to a unique piece of information, such as the CD serial number, so that the information entered maintains a connection to the particular CD card purchased to enable retrieval at a later time by that particular CD card.

The CD card can then be sent, via mail or otherwise, to the purchaser so that it may be given to the intended recipient, or the card can be sent directly to the intended recipient from the company offering the card and maintaining the web site.

When the card's recipient receives the CD card and puts it into the CD drive on a computer, the following steps occur automatically. The CD automatically looks to see if the proper software is present on the computer to run it correctly. If not, the CD will respond, for example, “Your computer doesn't have Quick-Time which is required to view your CD, would you like to install it now?” and an “Install Now” button is presented. After that, the CD looks for a telephone line, a modem and Internet software on the computer, and if additional software is required it will give the recipient another button option to install that as well. The CD then automatically causes the computer to access the web site at which the card was originally purchased, or a related web site.

Once at the web site, the CD retrieves the awaiting message left by the purchaser from the database for that particular CD and automatically displays it on the recipient's computer monitor. The personalized message may be, for example, “Happy Birthday Matt”, “Congratulations . . . dinner is on me!”, or any other personalized message that the purchaser wants and has entered. The message could also be a video, MP3, Audio book, or any other download selected by the purchaser of the product to be presented to the recipient.

After the personalized message is displayed, a program begins that is stored on the CD provided with the card. Preferably, the program uses the data entered by the purchaser of the card to select the type of information which will be displayed to the recipient on the computer. For example, if the card is a birthday card and the purchaser has entered the birth date of the recipient, the program on the CD uses that birth date information to determine what information available on the CD to display to that particular recipient. For example, if the recipient is born in September, the program preferably selects information relating to that month. Any other suitable data can be entered and selection criteria can be used to personalize the card for the recipient.

In other words, the CD preferably includes large amounts of information that, for example, relates to each month of the year or to many possible recipients, and the information provided by the purchaser enables the program to determine what information to display to that particular recipient, thereby enabling the cards to be personalized by the purchaser for the recipient, without the need for customizing the information stored on each CD sold with a card. This feature enables all of the CDs to contain the same information, but still allow each card to be customized by the purchaser for a particular intended recipient. In other words, the customization feature of the invention is used to “unlock” a particular subset of the total amount of information contained in the CD, thereby personalizing the CD for the recipient, without the need to actually produce a custom CD.

The program preferably provides the user with an interesting and/or entertaining video and/or audio presentation on the recipient's computer based on the unlocked information contained in the CD. It may, for example, provide information on birth flowers, birth stones, famous people having birthdays during that particular month, famous events occurring during that month, and/or any other suitable information. In one embodiment, the CD 62 contains odd facts, obscure trivia and fun information about, for example, a particular birthstone, birth flower, etc., such as where it comes from, why it may be unusual, and/or any other similar, related or other type of information that is desirable.

In accordance with an alternative embodiment of the instant invention, the card device 10 may be purchased by the purchaser at a retail store rather than by the on-line method described above. If the card is purchased in this manner, the sequence of personalization is slightly different as explained below. More particularly, after purchasing the card device 10 at the retail outlet or other store, the purchaser uses any computer and goes on-line to the web site described above. The user is then requested to enter the “Product Code” (CD serial number, for example), thereby allowing access to a secure data entry area. The first time a “product code” is entered, the web page automatically prompts the user to “enter personal greeting data.” This data is basically the same as that described above, i.e., name, birth date, and personalized message. This information is stored in a database as described above, and the purchaser can then give the card to its intended recipient.

Once the user receives that card and puts the CD in their computer, the CD automatically retrieves that information from the database and displays the personal greeting left by the purchaser on the recipient's monitor. In addition to personalized audio messages, personalized video messages may also be stored by the purchaser for later retrieval by the recipient of the card. The message may be entered as a “natural voice” which is then stored as a text/voice file, and is subsequently played back to the recipient in the purchaser's actual recorded voice when the recipient puts the CD in a computer. This natural voice feature can be used by the purchaser if the purchaser has a microphone during the on-line purchasing process. This feature can also be made available via a cell phone, or telephone customization process via a 1-900 line or the like. In other words, the information of the CD preferably provides an interesting, educational, and/or exciting multimedia display for the recipient of the card.

Another customizable feature that can be used in accordance with the present invention is that when the purchaser is customizing the CD on-line, he may add custom “gifting” to be included with the card to be presented to the recipient. This feature is driven by a “Giftbox” selection process available on the web site. The gifting process enables the purchaser to select at least some of a plurality of available gifts, such as free or discounted items, that the purchaser believes the recipient may enjoy receiving. The actual physical gifts selected are not included with the CD. Instead, coupons or vouchers for the gifts, which can later be used by the recipient to obtain the actual gift, are provided on the CD and can, for example, be printed therefrom when the recipient is viewing the CD presentation. The gifts may be any suitable type of gift that can be initially presented to the recipient, such free or discounted goods or services like communication services (cell phones, wireless and long distance telephone service), Internet access, software, flowers, movie videos or tickets, clothing and fashion products, cologne/perfumes, dining and small vacation packages, or the like. The content of the CD may provide an infomercial-type presentation relating to the selected gifts, and then provide the user with information on how to obtain the gifts, such as by printing a coupon good for movie tickets and/or other gift items. The CD may also provide hotlink functionality to enable the user to access web sites associated with the available gifts to, for example, learn more information about the gift or related products and services.

The above-described embodiments of the instant invention require that the purchased CD 62 be operable to automatically (or through instructions provided to the recipient) access the web site to retrieve the personal message left by the purchaser of the card device. In accordance with these embodiments of the invention, the CD may contain a default program or autogreeting feature that will run if, for some reason, the web site cannot be accessed. This default program may be operable to query the user for enough information to provide some level of customization for the recipient of the card, i.e., the program could ask for the date of birth information and then unlock certain CD information to provide a base level customized display presentation to the user.

However, in accordance with another embodiment of the invention, this base level customization used during Internet failure can be improved in the following manner. When the purchaser goes through the customization process described above, thus creating a unique “file” which is stored in the database by a host machine operating the web site for later retrieval by the CD when used by the recipient, the file information is also coded as a “Product Code” which is printed on the CD packaging at the fulfillment house which supplies the CD as it is prepared for shipping to the recipient. That product code can then, in case of an Internet failure, be asked for by the program on the CD upon execution thereof. When the code is entered by the recipient, it operates to unlock the same multimedia presentation that the purchaser intended without accessing the web site. In this manner, a customized presentation can still be presented to the recipient as intended by the purchaser without Internet access. The only missing information would be the personal message left by the purchaser at the web site, which cannot be accessed until the Internet failure is corrected.

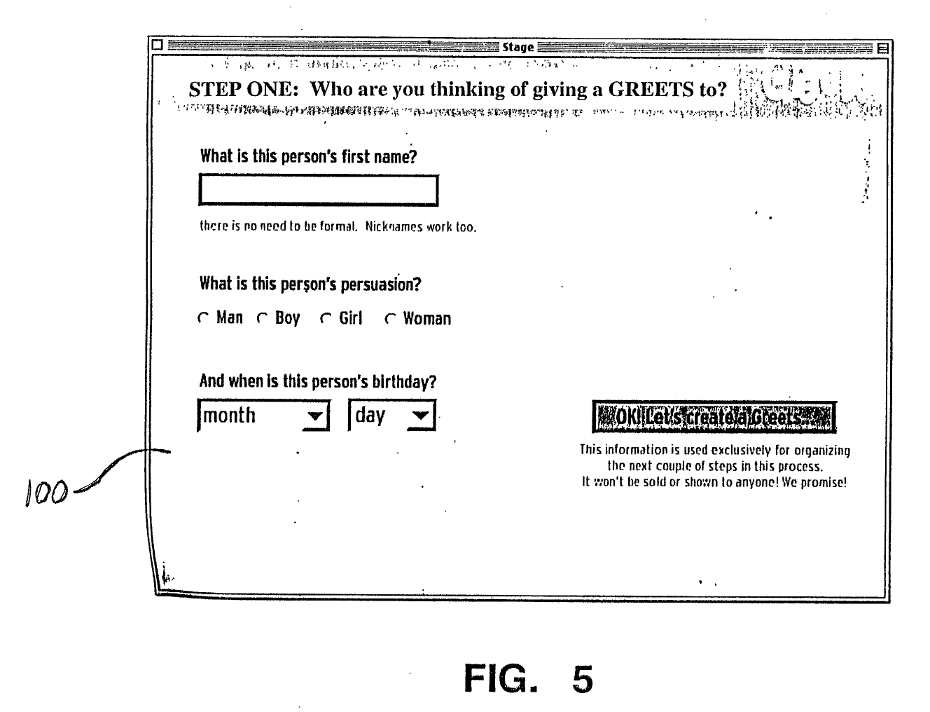

Another embodiment of the instant invention will hereafter be described with particular reference to FIGS. 5-9, wherein the CD is not intended to automatically access the Internet web site upon use by the recipient to obtain the personal message. Further details regarding customization of the CD card 62 are also described, which details can apply to any of the embodiments disclosed herein.

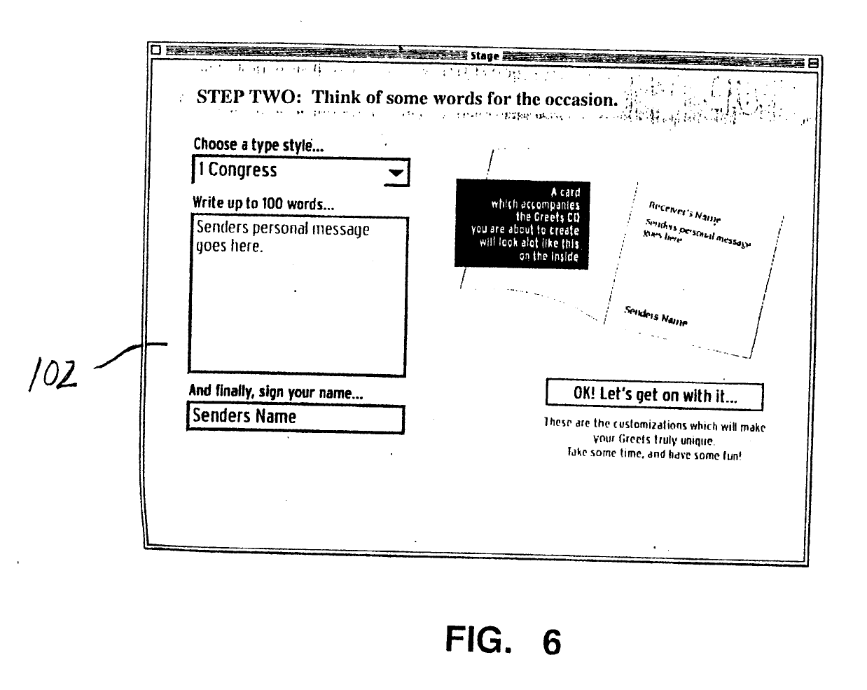

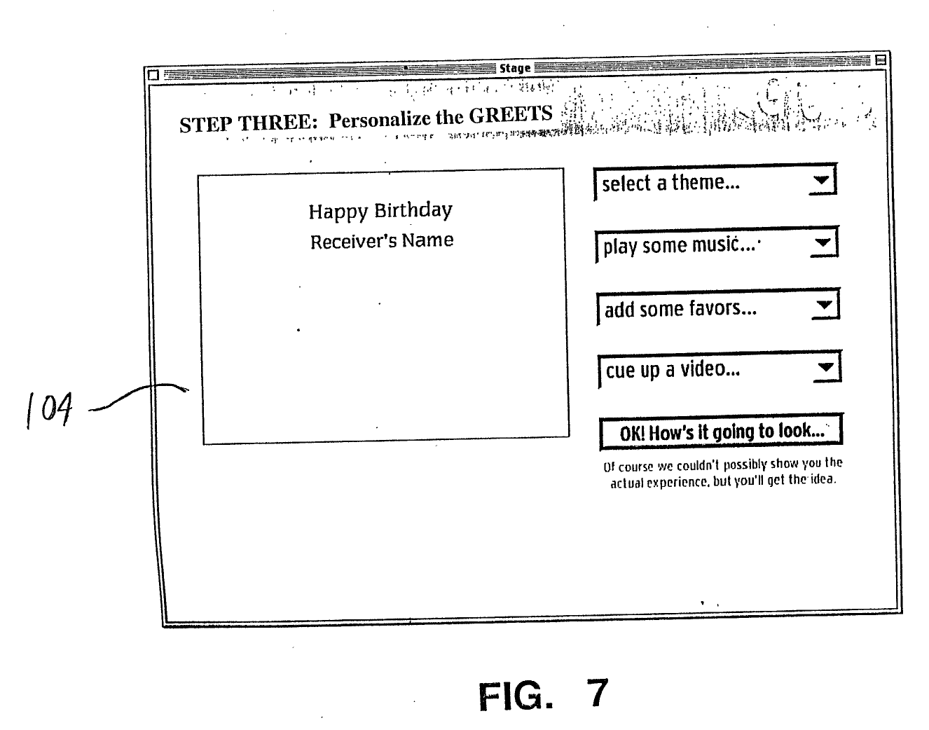

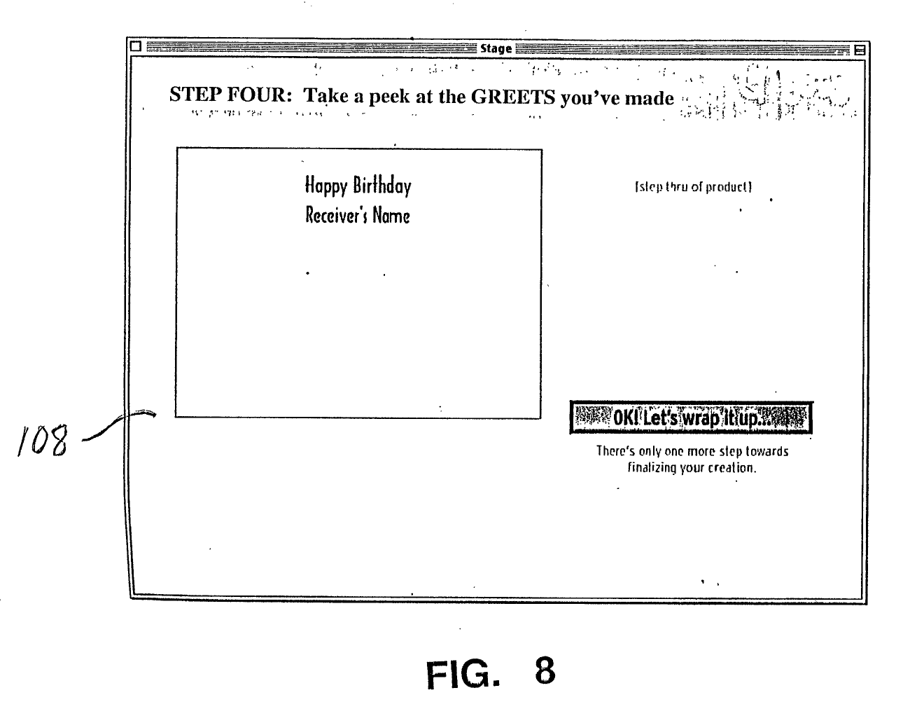

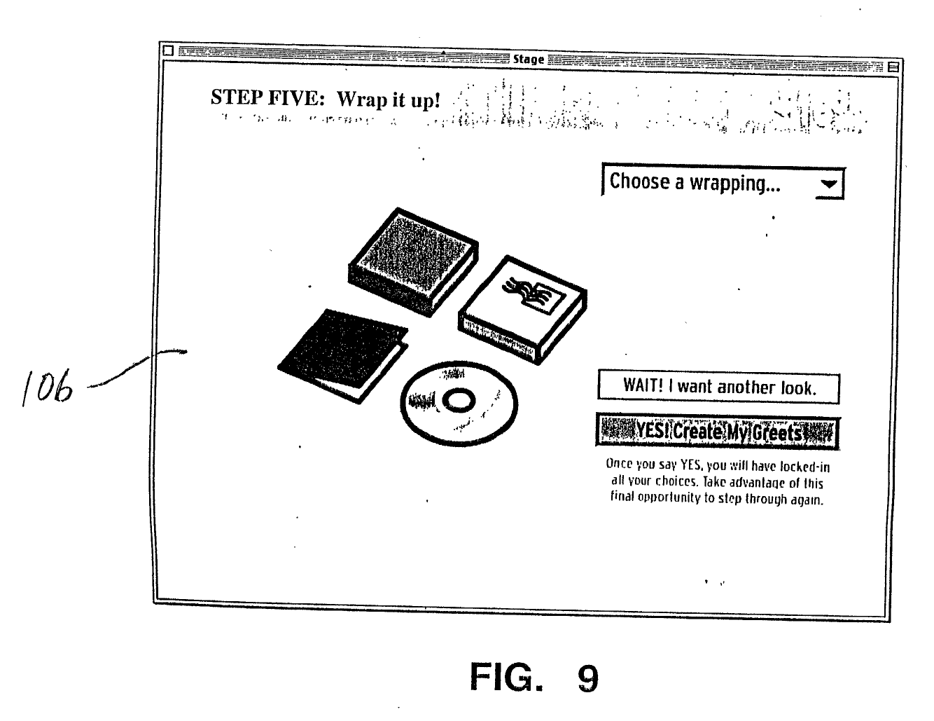

In accordance with this alternative embodiment, the CD 62 is a product that can be purchased from a specialized e-commerce web site. During the process of purchasing the CD, the purchaser is given the opportunity to customize the CD for the recipient in several ways, as will be explained in greater detail below. When visiting the web site, the sender is first asked to provide some basic information about the person to whom they desire to send the gift card 10, i.e., the gender, name and birthday of the intended recipient. Based on this information, a back-end database driven architecture provides the sender with a set of default starting “assets” for the CD card, which may include particular animations, background scenes, colors, sound, etc., generally considered to be appropriate for the recipient based on the information entered. An exemplary input display 100 is shown in FIG. 5 for entry of this information. The purchaser is then given the opportunity to deviate from the default settings to further customize the card. The choices that the user makes in this editing phase is preferably later used, as explained below, as part of the “Product Code.” In addition the sender is given the opportunity to write a personal message that is printed on the card stock or card accompanying the CD gift card 10. A sample exemplary input display screen 102 for entry of the personal message 104 and for further customizing the CD are shown in FIGS. 6 and 7, respectively. The sender is also given the opportunity to select the type of gift wrapping for the CD gift card 10, as shown in the exemplary display 106 of FIG. 9. The exemplary display 108 shown in FIG. 8 gives the purchaser the opportunity to view the customized selections made for the card. Once the purchaser has completed the customization process, the back-end system runs a Java servlet that builds the “Product Code,” as explained in more detail below. This product code and the personal message are printed on a greeting card that accompanies the CD 62. During playback of the CD 62 for the recipient, the recipient is prompted to enter the product code which is operable in conjunction with a control program on the CD card to unlock the appropriate assets on the CD for presentation to the recipient. Additional details of the above steps will now be described in greater detail.

As indicated above, a first embodiment of a process of customizing a CD card 10 in accordance with the present invention is preferably completed on-line at a dedicated web site. This customization is preferably completed using Macromedia Flash 4.0, along with a back-end web site architecture providing the functionality described herein. The customization may alternatively be completed using an automated/voice telephone capturing system. The preferred process of customization includes the following five main steps: providing basic demographics about the recipient (FIG. 5); writing a personal message (FIG. 6); setting product specific attributes (FIG. 7); reviewing current selections (FIG. 8); and selecting a wrap/box (FIG. 9). Each of the steps will now be explained in further detail below.

Upon entering a “Create a CD” section of the web site, the purchaser is first asked to provide basic information about the intended recipient, as shown in FIG. 5. Some examples of this information are receiver's gender, first and/or last name, birth day, birth month and/or the like. These basic questions may be modified depending on the type of occasion that the card is designed to be used for, such as Valentine's Day. Based on the purchaser's answers to these questions, the database pulls out a default set of assets that are generally considered appropriate for the recipient. For example, a 22 year old female's default may include satin backgrounds and flower animations, while a 9 year old boy's default may include a space ship background and balloon animations. In accordance with the invention, the defaults may be real-time defaults based on actual purchasers made for a given demographic using a database driven system.

The second step of the customization process involves writing a personal message that will be printed on a greeting card that accompanies the CD 62, as shown in FIG. 6. The personal message can preferably be up to 100 words or 500 characters long, but any suitable message size may be used. In addition, the user may also choose the type style or font for the card. This type style will be incorporated into the product code, and thus be operable to change the appearance of certain assets during the CD presentation. The personal message and the type style are transmitted to the product fulfillment house to be printed on the greeting card accompanying the CD.

The next step in the customization process involves editing the appearance and assets to be selected by the CD for presentation to the recipient, as shown in FIG. 7. When the purchaser enters the editing process, he/she is presented with a default set of assets based on the information that was previously entered. From these default assets, the sender may change the preferences by using, for example, available pull-down menus and/or buttons as shown on FIG. 7. As the sender makes new selections, he can see a real-time update of the current selections on the display. This allows the sender to quickly and easily see how the choices are effecting the CD card. Once the sender has determined which assets are appropriate, the choices are saved and later become part of the product code.

The next step in the process enables the purchaser to review all choices previously made, as shown in FIG. 8. In addition, the purchaser will have the opportunity to view a limited preview of the content of the CD presentation. Due to the limited bandwidth of the Internet, this feature preferably only includes a limited version of the content of the full CD presentation that will eventually be displayed to the recipient.

The final step in the customization process involves selecting the gift wrap/box that the CD gift card 10 will be shipped in to the recipient, as shown in FIG. 9. Once the sender has selected the appropriate gift wrap/box, all of the custom selections are passed out of the Flash movie to the back-end Java system for processing.

As indicated, once the sender has completed the “Create a CD” section of the web site, the Flash movie calls a Java servlet action entitled, for example, “AddGiftSet”. This action takes the choices made by the purchaser during the editing session and translates those choices into the first half of the product code. The second half of the product code is a database pointer that ties the current order to the custom choices made by the sender. Eventually, this product code is what determines which assets are shown to the recipient by the CD gift.

Once the order is confirmed, the product code is transferred to the fulfillment or distribution house, via the Internet or in any other suitable manner. Once the fulfillment house receives the order, the product code along with the personal message are printed on the appropriate greeting card. The greeting card, including the CD 62, are then placed in the selected gift wrap/box. The product is then placed in a mailing liner and sent to the appropriate shipping address, which is also obtained by the web site during the purchasing process.

When the recipient of the CD gift card 10 puts the CD 62 in his computer and runs the control program that is contained on the CD, he is prompted to enter the product code, which may be referred to as the “Party ID” which is printed on the product. As explained above, part of this product code informs the program on the CD of the selected subset of assets which are to be unlocked from the total assets contained on the CD for presentation to the recipient. The remainder of the product code preferably is used to identify the exact CD to the back-end Internet system. Preferably, upon entering the product code, the CD application runs the code through a check-digit to determine if the code is valid. If the code is valid, the application then runs the code through a series of resource look-up tables to assign values to the necessary variables to, for example, set the background, the music or sound, and any other attributes which have been selected to enable the customized multimedia presentation to be displayed to the recipient. The second half of the product code is used when the receiver of the CD clicks a link to the product web site that the CD was purchased from. This link sends the product code to the web site which can then be used by the company offering the product and maintaining the web site to verify that the recipient has received and used the CD gift.

As explained above, the Internet provides a unique and efficient way to customize and personalize on a real-time basis the specific content on the CD which will be displayed to the recipient of the gift. The dense multimedia content preloaded on the CD provides audio-visual graphics that cannot economically or efficiently be delivered over the Internet because of bandwidth requirements. For example, a sequence of full color images combined with stereo quality audio track takes approximately 1.5 minutes to view using the CD, while the same content delivered over the Internet, even with a 56kb connection, could take several hours to download and view.

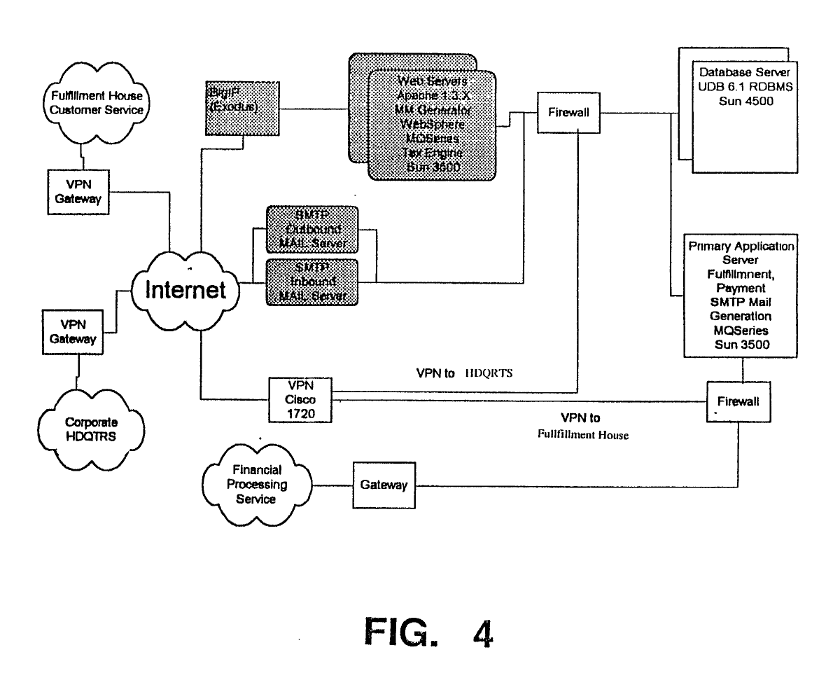

Referring now more particularly to FIG. 3, there is shown a general overview of the main system component and interfaces used in accordance with a first preferred embodiment of the instant invention, which includes the product web site 200, product fulfillment warehouse and services 208, financial processing services 210, web user browsers 204 and corporate headquarters 206, all of which preferably interact over the Internet 202. The major set of functional requirements used in accordance with the invention are gift composition, existing user management, gift order, site operation management, inventory management and customer support. The web site 200 is preferably designed as a high-performance, high availability Internet system with redundant subsystems and transparent fail-over. The web site can be mirrored for additional load balancing and availability. As shown in FIG. 4, the primary web site components include a load balancing server, web server, application servers, database servers, firewall, virtual private network (VPN) gateways, financial processing service central gateway, and SMTP mail services. The load balancing server works in concert with content web servers and commerce web servers to provide balanced distribution of users across the servers and to provide a transparent fail-over capability. This service is preferably provided by the remote hosting service, Exodus, and is based on BigIP software. The gift composition web servers preferably deliver streaming content using Macromedia Flash format via the Macromedia Generator Application server. The Apache 1.3.x HTTP server and the IBM Websphere servlet engine is preferably used to server the Flash files. Minimal business rules processing is done using these servers. Integration software is preferably implemented using industry standard, platform independent Java (JDK 1.1.X).

With respect to purchasing, the web server supports financial transactions using a Secured Socket Layer (SSL) session to the web user's browser. These servers interact with the Financial Processing Service for payment authorizations. The Application servers provide business rules processing for database processing, fulfillment processing, administration and maintenance processing and tax calculation. They will execute on dedicated back-end hardware. These servers are preferably connected using MQSeries message queue infrastructure. The database servers provide efficient data storage and business rules processing on a Relational Database Management System (RDBMS). These servers preferably execute the IBM Universal database (UDB) DB2 version 5.2/6.1. Firewalls, in the form of an integrated hardware and software device, are used to strengthen the protection for the web site from unauthorized access from the public Internet. It provides packet-filtering rules to limit the protocols and connection from the known addresses of the outside web servers and SMTP servers to and from the internal database server. The web site is preferably remotely hosted away from the corporate headquarters of the company offering the CD card product and the fulfillment warehouse. Both preferably have real-time connectivity to the web site. However, rather than build a private network, the web site is preferably designed to use Virtual Private Network (VPN) technologies to securely connect these geographically dispersed sites. VPN's are built with data encryption technology to “tunnel” securely through the public Internet. The VPN link is transparent to the users of the network. The VPN is preferably extended between the web site and the fulfillment house data center and carries the following classes of data traffic: 1) Automated, system to system interface (This interface is preferably based on XML 1.0 using suitable e-commerce DTD). This interface will be for product orders, order cancellations, and tracking requests; and 2) Web application to system interface. This interface is preferably a forward extension of a set of web browser pages from an application web server located at the web site. This facility is used by the fulfillment house data center personnel and customer service representatives. Content will be for product orders, order cancellations, tracking requests and manual transfer for bulk transactions (as a backup to the automated processes). The VPN is also extended to the web site and the corporate headquarters and has a similar interface described above. The content thereof is used for system processing, performance, financial and administrative reports. This VPN will be used by the corporate headquarters personnel to manage and monitor the remote web site. The financial processing service center gateway provides a real-time interface which connects the Commerce Web Servers with a third party financial processing service. This connection is used for payment authorizations, charges and charge reversals. The SMTP mail interface enables SMTP Mail to be used for order confirmation and shipping notification to web users who purchase product from the web site.

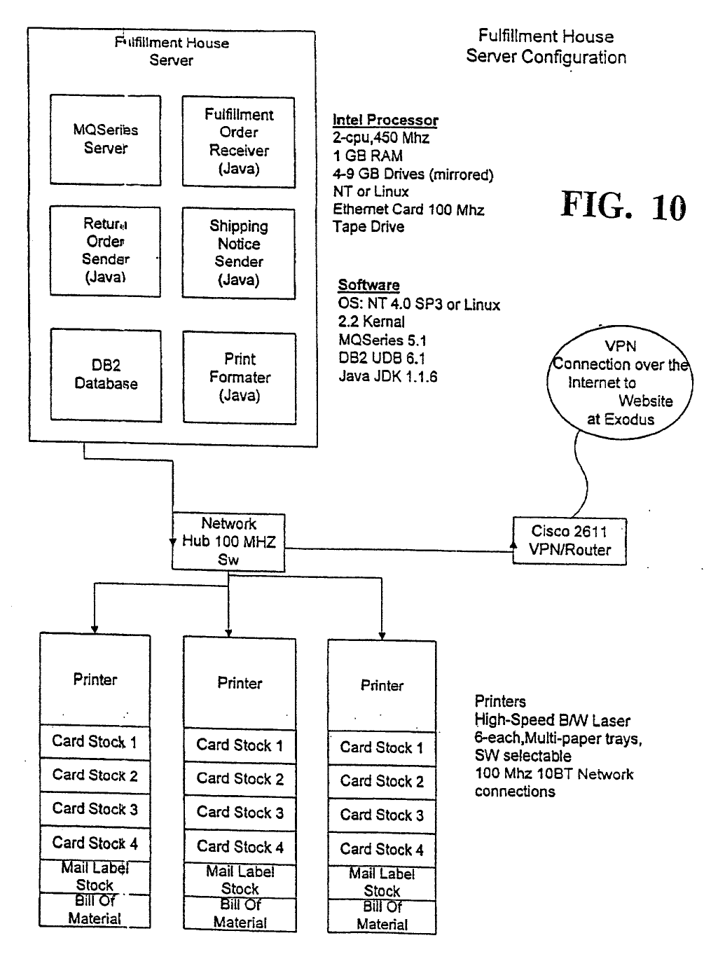

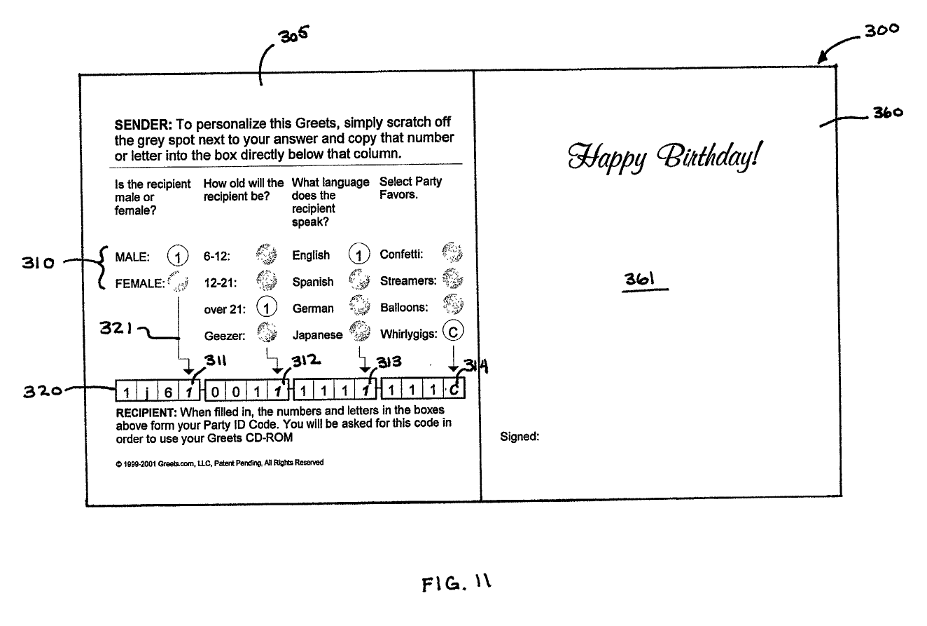

FIG. 10 shows an exemplary embodiment of the server architecture of the fulfillment house 208 shown in FIG. 3, which is used to fill the orders received for products ordered through the web site 200.

The delivered content of the web site is preferably designed to be highly interactive using multimedia features to keep the web user interested in the content and product offerings. This content is preferably delivered as a Macromedia Flash file streamed to the user's web browser. Viewing the Flash file may require a plugin from Netscape or the Internet Explorer browser. All presentations to the web user, up to the point of purchase, are preferably from the Flash player plugin executing the Flash file. This Flash file is personalized at the point of request by the Macromedia Generator application executing on the Content Web Server. This personalization includes the insertion of names and other references to enhance the web user's experience when using the web site to purchase the CD gift card product 10.

The following provides a base user scenario which occurs when a web user enters the product web site. If the web user has used the site previously, they are offered an opportunity to “login.” This feature enables some personalization of the web user's session. The exemplary scenario generally operates as follows: 1) the user enters data about the intended gift recipient; 2) the user selects theme elements such as humorous, romantic, etc.; 3) the user selects specific content elements corresponding to the selected theme; 4) the user enters a detailed message; 5) the user then completes the purchase using a supported process; 6) the financial processing service authorizes payment; 7) the user is notified that the purchase has been authorized and is given a tracking reference; 8) a detailed order is forwarded to the fulfillment house and placed in a fulfillment queue; 9) e-mail notification is then sent to the user confirming the order; and 10) when the order is shipped, a second e-mail notice is sent to the user confirming shipment.

In accordance with another embodiment of the invention, the web site may provide a service which enables users to record addresses and dates for a plurality of people for whom they would like to be reminded, by e-mail or otherwise, of upcoming dates related thereto. For example, the user could enter the name, address and birthday information, on a personal web page or the like, for all of the people in his/her family, which information is then stored in a database by the web site. The system is then programmed to send reminders to the user informing the user of the upcoming birthday, which reminder then gives the user the opportunity to order a customized CD gift for the family member as described above. The web site may provide database management functions to the users which enables the users to edit, add and delete information from their personal database or web page records. The personal page may show orders placed in the past, orders shipped, orders confirmed, number of days until recorded person's birthdays and/or the like information which enables the user to keep track of and manage information on people and special occasions.

In accordance with yet another embodiment of the invention, the CD greeting card 10 may be purchased through a traditional point-of-purchase retail display, while allowing the purchaser to customize the ultimate user's interactive experience by manually formulating a customization code without requiring interaction with a remote web site, in accordance with the following method and apparatus.

As shown in FIG. 11, a printed card 300 is packaged with the CD greeting card 10 comprising a customization code formulation panel 305 and a message panel 360, panels 305 and 360 being hinged together so as to form a closeable traditional card structure. Printed card 300 is preferably packaged with jewel case 54 in a single retail package, such as in a decorative gift box sized to receive both the jewel case 54 and printed card 300. Such packaging enables a purchaser to open the gift box and remove card 300, manually formulate a customization code (as set forth in greater detail below), scribe an original greeting or other message to the intended recipient on message panel 360, and replace card 300 into the gift box for delivery to the intended recipient.

Customization code formulation panel 305 enables the purchaser to generate a unique customization code based upon the characteristics of the intended recipient, and the desired content the purchaser wishes the user to view. In order to achieve this purpose, a number of preset recipient characteristics and content selections 310 are listed and categorically arranged on the card, such categories including by way of example only the intended recipient's gender, age, and language, as well as a variety of graphic schemes the purchaser may choose to have presented to the user. Adjacent each characteristic for a given category is a unique alpha-numeric character for that specific characteristic within the category. Thus, by way of example, under the “age” category, “6-12” may be provided the reference numeral “1”, “12-21” may be provided the reference numeral “2”, “over 21” may be provided the reference numeral “3”, and the age category “Geezer” may be provided the reference numeral “4.”

Preferably, the alpha-numeric reference characters relating to each specific recipient characteristic or content choice are printed on the card immediately adjacent the textual description of each choice, and are preferably covered with a removable, opaque, “scratch-off” layer as is well known in the art. Alternately, each recipient characteristic or content choice reference character may be covered with a readily removable adhesive sticker or the like.

Customization code generation panel 305 directs a user to select those characteristics and content selections they intend for the recipient by revealing the alpha-numeric reference character adjacent the textual description of such characteristic, such as by “scratching off” the covering over such character. Positioned below the listing of characteristics and content selections is a customization code listing 320 which has a separate character window for each digit of the customization code. As shown in the embodiment of FIG. 11, several of the digits of the customization code may be preprinted on customization code generation panel 305, with open windows dispersed within the code listing for receiving the user-selected reference characters. As shown in FIG. 11, windows 311, 312, 313, and 314 are initially left blank in order to receive the user-selected customizing reference characters. Preferably, an arrow 321 or other guiding indicia is provided to direct a user to enter each reference character in the appropriate position within the customization code such that the control program on the CD will properly comprehend the user's intention with respect to those selections.

The pre-formatted digits in the customization code may be set by the manufacturer to provide greeting cards of the instant invention for particular holidays or other occasions, or for particular themes. Thus, for example, a birthday card may have a first combination of preset digits establishing a default presentation of birthday-related content on the CD to present to the user, while a Valentine's Day card may have a second combination of preset digits establishing a default presentation of Valentine's Day-related content, and a generic greeting card may have a third combination of preset digits establishing a default presentation of content related to a particular theme, such as (by way of example only) sports, movies, music, space, and the like. Thus, variously configured printed cards may be provided in the retail package which are drawn to particular occasions and themes, but each CD-ROM provided in the greeting card package may contain the same content, such that only a single CD-ROM need be produced for distribution with widely diverse printed cards. Further, by freeing a manufacturer from the requirement of producing distinct multimedia CD-ROM's with varying content customized for particular occasions or themes, manufacturing costs are significantly reduced and inventory management is simplified.

Likewise, while only four windows are depicted as being left open in customization code listing 320, it should be noted that additional customization categories may be provided and additional windows within the customization code be left open to receive additional user-selected reference characters to even further customize the experience of the intended recipient.

Message panel 360 is provided to enable a purchaser to even further customize the greeting card for the intended recipient, having an open window 361 enabling the purchaser to write a message to the intended recipient, as with a traditional greeting card.

As with the previously described embodiments of the instant invention, after the purchaser has formulated the customization code and given the greeting card to the intended recipient, the user places the CD into the CD drive on a computer and proceeds through the same steps as with the greeting card that is customized through interaction with a remote server. More particularly, a control program on the CD-ROM initially confirms that the proper software is resident on the recipient's computer (e.g., “Quick-Time”), and prompts the user to install such software if necessary. Once the presence of such software has been confirmed, the control program prompts the user to input the customization code that had been formulated by the purchaser. As before, a portion of the customization code informs the program on the CD of the selected subset of assets which are to be unlocked from the total assets contained on the CD for presentation to the recipient, with the remainder of the code designating a specific CD being used. The control program again runs the code through a check-digit to determine if the code is valid and, if so, runs the code through a series of resource look-up tables to assign values to the necessary variables to set the various attributes of the multimedia presentation to be displayed.

After running the code through a series of look-up tables in order to set the attributes of the multimedia presentation to be displayed, the control program creates a preference file which is written to a memory storage device on the user's local computer, such as a hard disk drive. Such a preference file includes the particular customization code entered by the user, which code, as explained above, includes both a serial number or other unique identifier for the particular CD-ROM, DVD, or other computer readable storage medium and the control codes for controlling access to particular portions of the multimedia content. Thus, the preference file that is generated by the control program relates solely to the physical CD-ROM, DVD, or other computer readable storage medium then being used. Thereafter, a user will not be prompted to reenter a customization code, and the preference file will allow a user to experience the same multimedia display from the CD-ROM each time the user places that physical CD-ROM into an appropriate disk drive on the user's computer, without requiring the user to input the customization code for each use. Moreover, by creating such a preference file particularly associated with a single, unique, physical CD-ROM, DVD, or other computer readable storage medium, a user's unauthorized access to additional content on the CD-ROM or the like (such as by inputting modified customization codes) may be avoided. Further, in the event that the user has occasion to use more than one CD-ROM or the like embodying the instant invention, the user will be prompted to enter a customization code for that new CD-ROM, and a new preference file associated with the new CD-ROM will be written to the user's local computer, with each preference file only being operable to allow the presentation of specific content from the particular physical CD-ROM from which it was created.

The control program may also again provide the user with a link to a product web site on the Internet relating to the company which distributed the CD to the retail establishment from which it was purchased, such link sending the product code to the web site in order to enable the company to verify the distribution of CD's from particular retail establishments.

As with the previously described embodiment of a CD customized via a remote computer network, the point-of-purchase distribution method described above thus enables a greeting card purchaser to customize and personalize the content on the CD to be presented to the recipient in a highly convenient fashion, without requiring that multiple CD's having varied multimedia content be produced.

As is apparent from the description above, the instant invention enables personalized CD gift cards to be easily and quickly made in a fun and exciting manner. When a purchaser buys the card they can easily add a personalized message as well as customize the CD presentation for the particular intended recipient. The invention provides a customized CD gift card that can be viewed by the recipient at any time through use of a computer, as well as provides an effective and efficient system and method for enabling the personalization of the CD.

In accordance with the invention, and as a direct result of the foregoing, the invention enables a first person to provide a second person with an enjoyable, interesting and/or exciting customized multi-media experience, as a gift without having to actually “burn” a custom CD. However, the invention also includes and provides a more enhanced overall customization by combining the features described above with a “light burn” on the CD which may include data relating to photos, voice or videos uploaded to the web site's database by the first person, which would subsequently be sent via the VPN to the replication fulfillment house database or may be resident thereon and burned onto the CD for a particular recipient. This would provide a hybrid of technologies and would include the selection of customized information from the standard non-customized information as well a enable the sender to include additional customized information not available in the standard non-customized information on the CD. This alternative embodiment of the invention will become more economical as CD replication technology advances sufficiently to allow replication at a rate which would enable for unit production sufficient to accommodate a reasonable market share.

While the preferred forms and embodiments of the invention have been illustrated and described, it will be apparent to those of ordinary skill in the art that various changes and modifications may be made without deviating from the inventive concepts and true spirit of the invention as set forth above, and it is intended by the appended claims to cover all such changes and modifications which come within the true spirit and scope of the present invention.

What is claimed is:

1. A customized gift comprising:
a computer readable storage medium containing a control program and non-customized information; and
a customization code generation card, said customization code generation card further comprising a listing of viewable information selections, an alpha-numeric character associated with each selection, a removable opaque covering over each said alpha-numeric character, and a customization code listing, said customization code listing having a plurality of pre-printed characters and a plurality of open spaces for receiving user designated alpha-numeric characters;
wherein said control program is operable in response to input of a user-completed customization code to provide a customized display using information from said non-customized information selected based on said user-completed customization code.

2. The customized gift as defined in claim 1, wherein said user-completed customization code further comprises said pre-printed characters and a plurality of said designated alpha-numeric characters corresponding to a plurality of user-designated selections.

3. The customized gift as defined in claim 2, wherein said control program is operable to prompt a recipient of said gift for said user-completed customization code.

4. The customized gift as defined in claim 1, wherein said storage medium is a compact disk.

5. The customized gift as defined in claim 1, wherein said non-customized information includes information relating to a plurality of different age groups, and said user-completed customization code instructs said control program to display information regarding a particular age group from said plurality of different age groups.

6. The customized gift as defined in claim 1, where said non-customized information includes a plurality of different graphic schemes to present to a recipient, and said user-completed customization code instructs said control program to display a particular graphic scheme from said plurality of different graphic schemes.

7. The customized gift of claim 1, wherein said non-customized information includes a plurality of different possible themes for said gift, and said user-completed customization code instructs said control program to display a particular one of said themes.

8. The customized gift of claim 1, wherein said customization code generation card is hingedly attached to a message card, said message card defining a space for receiving a written message from a user to a recipient of said gift.

9. A method for enabling a first person to produce a customized gift for a second person, comprising:
providing a computer-readable storage medium having a control program and non-customized information stored thereon;
prompting said first person to make selections from a listing of information selections;
prompting said first person to complete a customization code with alpha-numeric characters associated with each said selection to generate a completed customization code;
causing said control program to request said completed customization code from said second person; and
using said completed customization code to select information from said non-customized information to provide a customized display to said second person.

10. The method of claim 9, said step of prompting said first person to make selections further comprising the steps of prompting said first person to make selections from said listing based upon said second person by removing a covering over an alpha-numeric character adjacent any of said selections.

11. The method of claim 10, said step of prompting said first person to complete a customization code further comprising the step of prompting said first person to enter into a customization code listing the uncovered alpha-numeric characters adjacent said selections.

12. The method of claim 9, wherein said non-customized information includes information relating to a plurality of different age groups, and the step of prompting said first person to make selections includes prompting said first person to select an age group from said plurality of different age groups.

13. The method of claim 9, wherein said non-customized information includes a plurality of different graphic schemes to present to a recipient, and the step of prompting said first person to make selections includes prompting said first person to select a graphic scheme from said plurality of different graphic schemes.

14. The customized gift of claim 9, wherein said non-customized information includes a plurality of different possible themes for said gift, and the step of prompting said first person to make selections includes prompting said first person to select a theme from said plurality of different possible themes.

15. The customized gift of claim 9, wherein said control program is operable to present a customized audio and visual display to said second person based on said completed customization code.
